(19) United States
(12) Patent Application Publication
(10) Pub. No.: US 2010/0320032 A1
(43) Pub. Date: Dec. 23, 2010

(54) METHOD FOR MANUFACTURING AN ENDLESS FIBRE-REINFORCED PLASTIC ELEMENT, AS WELL AS SUCH AN ELEMENT

(75) Inventors: Johannes Theodorus Maria Rijken, Dk Voerendaal (NL); Maurice Hendrik Hubertus Maria Van Avesaath, Lanaken (BE)

Correspondence Address: GIFFORD, KRASS, SPRINKLE,ANDERSON & CITKOWSKI, P.C, PO BOX 7021, TROY, MI, 48007-7021, US

(73) Assignee: INXTRU B.V., De Geleen (NL)

(21) Appl. No.: 12/739,272

(22) PCT Filed: Oct. 23, 2008
(86) PCT No.: PCT/NL08/00240

§ 371 Date: Aug. 9, 2010

(30) Foreign Application Priority Data
Oct. 23, 2007 (NL) 1034570

(51) Int. Cl. E04G 5/08; B29C 47/14; B32B 5/12

(52) U.S. Cl. 182/222; 264/177.2; 428/113

(57) ABSTRACT

The present invention relates to a method for manufacturing an endless, fibre-reinforced plastic element, wherein a granulate based on a thermoplastic polymer, fibres and possibly other additives are extruded into the element via an extrusion process. The present invention further relates to a fibre-reinforced plastic element obtained by extruding a granulate based on a thermoplastic polymer, fibres and possibly other additives.

The present invention relates to a method for manufacturing an endless, fibre-reinforced plastic element, wherein a granulate based on a thermoplastic polymer, fibres and possibly other additives are extruded into the element via an extrusion process. The present invention further relates to a fibre-reinforced plastic element obtained by extruding a thermoplastic polymer, fibres and possibly other additives.

A method for manufacturing an endless, fibre-reinforced plastic element is known, for example from US patent Application U.S. 2004/0040788, in which, besides extrusion, also the injection moulding method is mentioned. A fibre-reinforced plastic element is also known from U.S. Pat. No. 6,131,700, which plastic element is made by using the mould technology.

The present inventor is active in the field of scaffold construction, in which use is made of wooden planks and steel platforms according to the traditional method. Erecting scaffolding comprising wooden planks and steel platforms is frequently considered to be physically hard work.

Thus it is an object of the present invention to provide a method for manufacturing fibre-reinforced plastic elements by which lightweight elements are obtained. The fibre-reinforced plastic elements obtained by using such a method must meet current European and Dutch requirements regarding the mechanical properties of scaffold platforms, whilst it must be possible to use the plastic elements in traditional and in system scaffolding construction.

Another object of the present invention is to provide a method for manufacturing fibre-reinforced plastic elements, which plastic elements are easy to assemble and disassemble in a construction system.

Yet another object of the present invention is to provide a method for manufacturing fibre-reinforced plastic elements, which elements have a long life, which are fully recyclable and which, in addition, are suitable for large-scale production at low cost.

The method as referred to in the introduction is characterised in that said extrusion of the granulate for obtaining the element is carried out by using fibres having a length of 5-50 mm.

One or more of the above objects are accomplished by using the aforesaid fibres. The present inventor has found that the special dimension of the fibre is crucial in providing the fibre-reinforced plastic element with the mechanical properties that are required of, for example, scaffold platforms. Using the extrusion process, a homogeneous melt of the fibres is obtained, so that substantially uniform mechanical properties can be obtained throughout the fibre-reinforced plastic element. The present inventors have thus found that an increase of the E-modulus impact and processing is effected by using the special fibre length in the polymer matrix.

The fibres used in the present invention preferably have a length of 10-30 mm, in which case a diameter of 10-30 μm is preferred.

The amount of fibres in the element obtained after extrusion preferably ranges between 10-60 wt. %, based on the weight of the element, in order to thus obtain the desired mechanical properties.

The thermoplastic polymer used in the present invention is preferably selected from the group of polyolefins, such as polyethylene and polypropylene, acrylonitrile butadiene styrene (ABS), styrene, polyamide and polyesters, or a combination thereof, wherein the MFI (Melt Flow Index) of the polymer used preferably ranges between 2-50, measured according to ISO 1183. Such an MFI value makes it possible to mix the fibre homogeneously in the melt during the extrusion process, with the mechanically strength of the thus obtained composite of polymer, fibre and any other additives used in the extrusion process being such that the extent of deflection of the extruded element is minimised. In addition, the fibres are thus prevented from being crushed into small particles during the extrusion process, which particles do not sufficiently contribute to the desired mechanical properties of the fibre-reinforced plastic element. It is assumed that as a result of the use of fibres having a specific length, the fibre is mixed into the plastic melt in the extruder, thus forming a kind of reinforcement, so that elements are obtained, partially on account of the provision of the extruder die (outflow opening) and the calibration step that is carried out after the extrusion step.

The present inventor has found that very good results as regards mechanical properties and durability are obtained if a polypropylene homopolymer and/or copolymer having an MFI value of 2-40, in particular 5-20, is (are) used.

To realise a very good mixing result of the fibres in the polymer melt, it is preferable if a screw having an L/D ratio z 25 is used in the extruder.

It is furthermore preferable to use a granulate of polypropylene and glass fibre and possibly other additives, wherein in particular the amount of glass fibre is 25-40 wt. %, based on the weight of the element obtained after extrusion, whilst the graduate that is used is a matrix of thermoplastic polymer with fibres incorporated therein.

Glass fibre, polyester fibre and carbon fibre, or a combination thereof, have proved to be suitable fibres, in which regard especially Performax glass fibres (trademark) (marketed by Owens Corning) and, after processing thereof, Stamax (marketed by Sabic Europe) may be mentioned, viz. a glass fibre having a length of 12.5 or 25 mm and a diameter of about 20 μm. The granulate preferably has a dimension of 0.1-25 mm, in particular 6-20 mm.

The present invention further relates to a fibre-reinforced plastic element obtained by extruding a granulate based on a thermoplastic polymer, fibres and any other additives, wherein at least 25%, preferably 50%, of the total amount of fibres present in the extruded element have a length of at least 2.5 mm, in particular 3 mm. The inventors have found that good results are obtained by starting from a fibre length of at least 10 mm, for example 12 mm, whilst at least ⅓ of the fibres in the extruded end product have a fibre length of at least 2.5 mm. The fibres will be reduced as a result of the extrusion operation, although care must be taken, for reasons pertaining to mechanical strength, that at least 25%, in particular 50%, of the total amount of fibres in the extruded end product have a length of more than 2.5 mm.

Using the present method, elements such as sections, plates, pipes and the like having a thickness of at least 1 mm are obtained, in particular elements having a thickness of 2-5 mm. Such elements can be reduced, for example cut, to the desired length. To obtain good mechanical properties, it is desirable that at least 50% of the total amount of fibres present in the element obtained after extrusion has a length of at least 10 mm.

The present fibre-reinforced plastic element obtained by extrusion is preferably elongate in shape, comprising a bottom wall and an upper wall, which are interconnected by partitions that extend at least substantially perpendicularly to the bottom wall and the upper wall.

To obtain good mechanical properties, the bottom wall and the upper wall are preferably interconnected by side walls on their long sides, in which regard it is in particular preferable if at least one of said side walls comprises receiving means for receiving a connecting element for connecting at least two plastic elements together in longitudinal direction.

In a special embodiment it is preferable if said receiving means is configured as a channel extending in the longitudinal direction of the plastic element, which channel is at least partially surrounded by an enclosing wall, whilst it may furthermore be preferable in specific embodiments if at least one of the side walls comprises further receiving means for receiving a further connecting element for connecting two or more plastic elements together in transverse direction.

According to another possibility, at least one of the side walls comprises two receiving means, the enclosing wall of which defines a further receiving means located between the two aforesaid receiving means for receiving a further connecting element for connecting two plastic elements together in transverse direction, which further receiving means is a slot having a substantially C-shaped cross-section, whose opening faces away from the plastic element.

The present fibre-reinforced plastic element is further characterised in that said further receiving means is arranged for receiving said further connecting element in an at least substantially form-locked manner.

The present invention further relates to scaffolding for construction work, comprising a frame consisting of uprights provided at suitable heights with walkways comprising interconnected floor members, which floor members are at least substantially configured as the present, fibre-reinforced plastic elements as discussed in the foregoing. More generally, the present invention further relates to the use of the present fibre-reinforced plastic element in a supporting structure. Especially mentioned in this regard is the use of the present element as a partition wall (sheet piling) to be used in civil engineering applications and for fencing. The present plastic element is in particular used in the construction industry, in particular as part of a structure.

The present inventors have found that the present element is capable of absorbing much larger forces than the polymer per se. The present inventors have furthermore found that an endless, fibre-reinforced plastic element can be obtained by using long fibres in combination with a low-viscosity polymer, viz. having a high MFI value. The special selection of low-viscosity polymer has made it possible to retain a long fibre in the final element obtained by extrusion, with the low-viscosity polymer furthermore providing an adequate distribution of the long fibre in the final element. The special use of a long fibre imparts a high impact resistance to the fibre-reinforced plastic element that is eventually obtained, whilst the network of fibres in the polymer ensures that a high-strength element having a low specific weight is obtained.

The present invention will now be explained by means of a number of examples, in which connection it should be noted, however, that the invention is by no means limited to such special examples.

### EXAMPLES

A Battenfeld single screw extruder (type techBEX 1-40-25D, techBEX 1-60-25 D, techBEX 1-90-25 D or BEX 1-120-25 D) provided with a die and with calibration means, wherein the extruded product was cooled by contact with water, was operated at a fixed screw speed and a fixed temperature setting, viz. 185° C., 190° C. en 200° C. The fibre that was used was a long glass fibre (type Stamax 60YM240, length of the glass fibre, abbreviated as LGF in the table: 12.5 mm), whilst polypropylene, homopolymers and copolymers having variable MFI values were used as the polymer. Mechanical properties, in particular the E-modulus and the tensile strength, of the elements thus extruded were determined. The results are summarized in the table below.

TABLE

| Type of polymer and amount | | | Homo- | | |
|---|---|---|---|---|---|
| of fibre in the element | Energy | Shape | geneity | E- | Tensile |
| after extrusion | absorption | stability | of melt | modulus | strength |
| PP MFI = 2 | +/− | − | + | − | + |
| PP MFI = 2 + 30% LGF | −/+ | ++ | + | ++ | ++ |
| PP MFI = 15 | +/++ | −− | +/++ | − | +/− |
| PP MFI = 15 + 30% LGF | +/++ | ++ | ++ | ++ | ++ |
| PP MFI = 25 | ++ | −− | ++ | − | − |
| PP MFI = 25 + 30% LGF | ++ | + | ++ | ++ | +/++ |
| PP MFI = 45 | ++ | −−¹⁾ | ++ | n.a. | n.a. |
| PP MFI = 45 + 30% LGF | ++ | −/+ | +/++ | ++ | −/+ |

Note:
*¹⁾ not possible to form a solid element.

The table above clearly shows that extruding polypropylene having an MFI value of 2 is difficult, which means that it is difficult to produce a form-retaining element. If an amount of 30% (based on the volume of the element obtained after extrusion) long glass fibres is added to the aforesaid polymer, the shape stability increases considerably, and good results as regards E-modulus and tensile strength are obtained. Furthermore it is apparent that it is very difficult to extrude a form-retaining element when polypropylene having an MFI value of 15 is used, but that the addition of 30% (base on the volume of the element obtained after extrusion) long glass fibres leads to acceptable values both as regards shape stability and as regards homogeneity. If polypropylene having an MFI value of 25 is extruded, it is not possible to obtain a solid moulded element. If an amount of 30% (based on the volume of the element obtained after extrusion) long glass fibres is added, both the shape stability and the homogeneity values are acceptable. Extruding a polypropylene matrix having an MFI value of 45 was found to be impossible. From the experimental data thus obtained it follows that it is possible to extrude thermoplastic polymers having an MFI value of 2-40 if, in addition to the aforesaid thermoplastic polymer, fibres having a length of 5-50 are added to the extruder.

In a special embodiment it is possible to provide the present element with metal side strips, which may or may not be provided with suspension hooks which extend over the side over the element, being fixed thereto, so that a strong, self-supporting element/platform suitable for various uses is formed. It is also possible to mount electric lighting (for example low-voltage LED light) in the present element (in cavities between the upper side and the bottom side), so that the artificial light will shine through the translucent element during use of the element and there will be permanent lighting at the place of work, so that a good and safe, lighted work place is provided 24 hours a day. Further possible uses of the present element include, for example, use thereof as raised floor elements, temporary building structures, computer spaces, container bottoms, garden fencing and furniture.

The present element is also suitable for transporting liquids, gases and/or solids therein. Special uses furthermore include maritime and shipbuilding applications, for example in sheet piling, dike elements, camp sheeting, jetties, quays and decks. Possible uses in the construction industry include use thereof as beams, roof and facade panels, sections, supporting and housing solar or energy cells/panels and sheet piling, but also as pipe and cable ducts and underlayer elements for market gardening applications. Furthermore they can be used as planks for drying, storing and displaying products from the agricultural, dairy (cheese, among other products), foodstuffs and pharmaceutical industries during and after preparation thereof, with the present element allowing easy cleaning and sterilisation.

The present invention will now be explained in more detail by means of a description of preferred embodiments of a fibre-reinforced plastic element according to the invention, in which reference is made to the following figures:

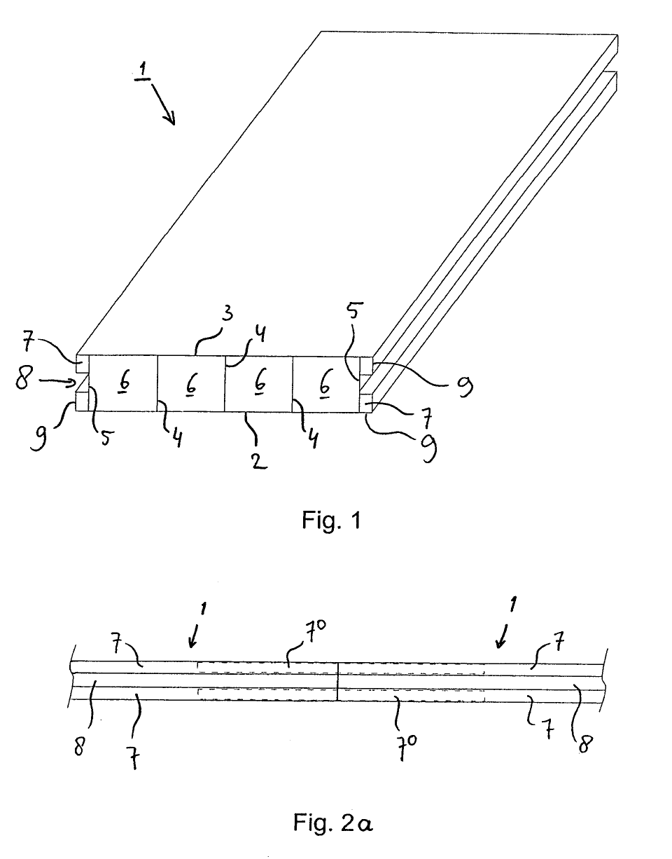

FIG. 1 schematically shows in perspective view a fibre-reinforced plastic element according to the present invention;

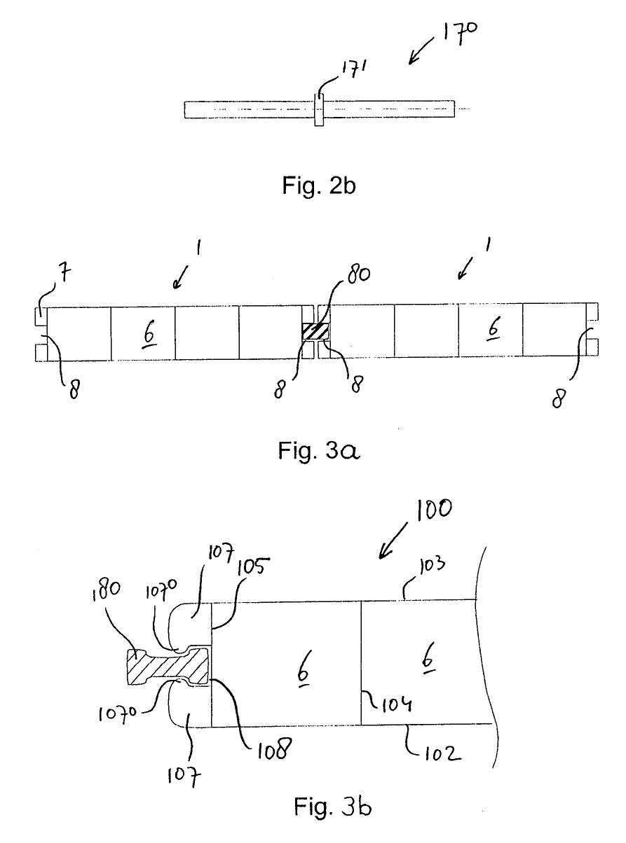

FIG. 2a is a side view of two parts of plastic elements according to FIG. 1, which are connected together in longitudinal direction;

FIG. 2b is a side view of another embodiment of a connecting element for connecting two plastic elements according to FIG. 1 together in longitudinal direction;

FIG. 3a is a front view of two plastic elements according to FIG. 1, which are connected together in transverse direction.

FIG. 3b is a front view of apart of another preferred embodiment of a fibre-reinforced plastic element according to the present invention.

The fibre-reinforced plastic element 1 according to the present invention that is shown in FIG. 1 is more specifically a plastic element intended for use as a scaffolding plank. In practice, such a scaffolding plank has a length of 5 m, a width of 23 cm and a height of 5.5 cm, for example, which values should not be construed as limitative, however. The plastic element 1 is built up of a bottom wall 2 and an upper wall 3, between which partitions 4 extend. On their the longitudinal sides, the bottom wall 2 and the upper wall 3 are interconnected by side walls 5. Channels 6 extending in the longitudinal direction of the elements are formed in the plastic element 1, which channels are surrounded by the bottom wall 2, the upper wall 3, at least one partition 4 and possibly a side wall 5.

Two channels 7 extending in the longitudinal direction of the plastic element 1 are formed on both side walls 5 for connecting the two above-described plastic elements 1 together in longitudinal direction in a simple manner, which channels are surrounded by enclosing walls 9 on the outer side of the plastic element 1. Since a side wall 5 is provided with two such channels 7, which channels are spaced some distance apart, a C-shaped slot 8 is formed between part of the enclosing wall 9 of the respective channels 7, which slot can be used for connecting two plastic elements 1 together in transverse direction. All the walls 2, 3, 4, 5, 9 of the above-described plastic element 1 have a thickness of 3. mm. Walls which are thicker or less thick are also suitable, of course, whilst individual walls may have mutually different thicknesses.

FIG. 2a shows a pin 70, which is used for connecting two plastic elements 1 (partially shown in FIG. 2a), which abut each other on their short sides, together in longitudinal direction. To that end the pin 70 is inserted a specific length into a channel 7 of one plastic element 1, after which a corresponding channel 7 of the other plastic element 1 is slid over the projecting part of the pin 70 so as to thus couple two plastic elements together in a simple manner. The pin 70 has a cross-sectional shape adapted to the internal shape of the channel 7. The pin 70 to that end has an at least substantially square cross-section. A hexagonal or round cross-section, for example, is also suitable; To realise a solid connection of the two plastic elements 1, the pin 70 is inserted into the channel 7 with some resistance. The material of the pin 70 is the same as the material of the element 1, but also another material, such as wood, will be quite suitable.

FIG. 2b shows another preferred embodiment of the pin 170 for connecting two plastic elements 1 together in longitudinal direction. Said pin 170, which has a round cross-section, is centrally provided with a collar 171 or, in other words, a part having a slightly larger diameter. The use of such a pin 170 prevents the pin 170 from being completely inserted into one of the two plastic elements 1 to be connected together when two plastic elements 1 are being connected together in longitudinal direction, since the collar 171 has a diameter that has been selected so that it does not fit in the channel 7.

In FIG. 3a two plastic elements 1 are shown in front view, which plastic elements are connected together in transverse direction by a connecting element 80. To that end, the elongated connecting element 80 is inserted into slots of the plastic elements 1 to be connected together. The length of the connecting element 80 may be the same as the length of the plastic elements 1, this is not necessary for effecting a solid connection between two abutting plastic elements 1, however, a smaller or a greater length will also be satisfactory. The height of the connecting piece 80 is such that it can be inserted into the slot 8 with some resistance. In practice, a number of elements connected together in transverse direction in this manner is retained in transverse direction between vertical structural members of a scaffold. In a special embodiment it is also possible, using a corresponding connecting element, to connect the present plastic elements together in longitudinal and in transverse direction. The material of the connecting element 80 is the same as the material of the element 1, but also another material, such as wood, will be quite suitable.

FIG. 3 is a partial front view of a fibre-reinforced plastic element 100 according to the present invention. The plastic element 100 is shaped in the same manner as the above-described plastic element 1. The plastic element 100 thus comprises an upper wall 103 and a bottom wall 102, which are interconnected by partitions 104 and side walls 105. The plastic element 100 further comprises two channels 107 at the location of the two side walls 105 (in FIG. 3a one side wall 105 provided with channels 107 a shown). Said channels 107 are shaped in such a manner that a C-shaped slot 108 is formed between two channels 107 arranged one above the other, with two projecting parts 1070 of the enclosing wall of the channels 107 making it possible to fit an at least substantially I-shaped connecting element 180 in the slot 108 in a form-locked manner by sliding the connecting element 170 into the slot 107 from the short end of the element 100. Because the connecting element 180 is accommodated in the slot 108 in a form-locked manner, two plastic elements 100 to be connected together in transverse direction can be connected together with a high degree of reliability. For the sake of completeness it is noted in this regard that both the connecting element 180 and the connecting element 80 are solid elements. It is also possible to use thin-walled connecting elements. The same goes for the pins 70 and 170.

By connecting individual plastic elements 1, 100 together both in longitudinal direction and in transverse direction by means of the above-described pins 70, 170 and/or connecting elements 80, 180, a floor can be formed of the aforesaid plastic elements. Such a floor is very suitable for use as a gangway in scaffolding used for construction work.

1. A method for manufacturing an endless, fibre-reinforced plastic element, wherein a granulate based on a thermoplastic polymer, fibres and possibly other additives are extruded into the element via an extrusion process, characterised in that said extrusion process of the granulate for obtaining the element is carried out by using fibres having a length of 5-50 mm.

2. A method according to claim 1, characterised in that the extrusion process for obtaining the element is carried out by using fibres having a length of 10-30 mm.

3. A method according to claim 1, characterised in that the amount of fibres is 10-60 wt. %, based on the weight of the element obtained after extrusion.

4. A method according to claim 1, characterised in that the MFI (Melt Flow Index) of the thermoplastic polymer used ranges between 2-50, measured according to ISO 1183.

5. A method according to claim 1, characterised in that said thermoplastic polymer is selected from the group consisting of polyolefins, such as polyethylene and polypropylene, acrylonitrile butadiene styrene (ABS), styrene, polyamide and polyesters, and a combination thereof.

6. A method according to claim 5, characterised in that said polyolefin is a polypropylene homopolymer and/or polypropylene copolymer having an MFI value of 2-40, in particular 5-20, measured according to ISO 1183, is (are) used.

7. A method according to claim 1, characterised in that said extrusion process uses a screw having an L/D ratio≧25.

8. A method according to claim 1, characterised in that the fibre is selected from the group consisting of glass fibre, polyester fibre and carbon fibre, or a combination thereof.

9. A method according to claim 1, characterised in that the fibre used in the extrusion process has a diameter of 10-30 μm.

10. A method according to claim 1, characterised in that the granulate comprises polypropylene and glass fibre and possibly other additives, the amount of glass fibre being 25-40 wt. %, based on the weight of the element obtained after said extrusion process.

11. A method according to claim 1, characterised in that the granulate that is used is a matrix of said thermoplastic polymer with fibres incorporated therein.

12. A method according to claim 11, characterised in that the granulate has a dimension of 0.1-25 mm, and in particular 6-20 mm.

13. A fibre-reinforced plastic element obtained by extruding a thermoplastic polymer, fibres and any other additives, characterised in that at least 25% of the total amount of fibres present in the element obtained after extrusion have a length of at least 2.5 mm.

14. A fibre-reinforced plastic element according to claim 13, characterised in that at least 50% of the total amount of fibres present in the element obtained after extrusion have a length of at least 2.5 mm.

15. A fibre-reinforced plastic element according to claim 13, characterised in that the thickness of the element obtained after extrusion is at least 1 mm.

16. A fibre-reinforced plastic element according to claim 13, characterised in that at least 50% of the total amount of fibres present in the element obtained after extrusion has a length of at least 10 mm.

17. A fibre-reinforced plastic element according to claim 13, characterised in that the plastic element is elongate in shape, comprising a bottom wall and an upper wall, which are interconnected by partitions that extend at least substantially perpendicularly to the bottom wall and the upper wall.

18. A fibre-reinforced plastic element according to claim 17, characterised in that the bottom wall and the upper wall are interconnected by side walls on their long sides.

19. A fibre-reinforced plastic element according to claim 18, characterised in that at least one of said side walls comprises a slot for receiving a connecting element for connecting at least two plastic elements together in longitudinal direction.

20. A fibre-reinforced plastic element according to claim 19, characterised in that said slot is configured as a channel extending in the longitudinal direction of the plastic element, which channel is at least partially surrounded by an enclosing wall.

21. A fibre-reinforced plastic element according to claim 18, characterised in that at least one of the side walls further comprises a slot for receiving a further connecting element for connecting two or more plastic elements together in transverse direction.

22. A fibre-reinforced plastic element according to claim 19, characterised in that at least one of the side walls further comprises a second slot, the enclosing wall of which defines a further third slot located between the slot and the second slot for receiving a further connecting element for connecting two plastic elements together in transverse direction.

23. A fibre-reinforced plastic element according to claim 21, characterised in that the slot having has a substantially reshaped cross-section, whose opening faces away from the plastic element.

24. A fibre-reinforced plastic element according to claim 21, characterised in that the slot is arranged for receiving said further connecting element in an at least substantially form-locked manner.

25. Scaffolding for construction work, comprising a frame comprising uprights provided at suitable heights with walkways and interconnected floor members, characterised in that said floor members are at least substantially configured as fibre-reinforced plastic elements according to claim 13.

26. (canceled)
